(19) United States
(12) Patent Application Publication
(10) Pub. No.: US 2009/0252953 A1
(43) Pub. Date: Oct. 8, 2009

(54) ARRANGEMENT COMPRISING NANOPARTICLES, AND METHOD FOR THE PRODUCTION THEREOF

(76) Inventors: Frank Arndt, Berlin (DE); Jens-Christian Holst, Berlin (DE); Jens Dahl Jensen, Berlin (DE); Ursus Krüger, Berlin (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/374,396

(22) PCT Filed: Jul. 19, 2007
(86) PCT No.: PCT/EP07/57464

§ 371 Date: Jan. 21, 2009

(30) Foreign Application Priority Data
Jul. 21, 2006 (DE) 10 2006 033866.9

(51) Int. Cl. B32B 5/16; B05D 1/36; B05D 5/12

(52) U.S. Cl. 428/328; 427/201; 427/123; 427/199; 977/948; 977/773

(57) ABSTRACT

An arrangement (90) has a support (10) and nanoparticles (40, 70) that are located thereupon. At least two nanoparticles (40, 70), both of which are made of a metal material (M1, M2) and are different regarding the metal material, are disposed at a distance from one another on a surface (130) of the support (10). The two metal materials have a different degree of preciousness.

### CROSS-REFERENCE TO RELATED APPLICATIONS

This application is a U.S. National Stage Application of International Application No. PCT/EP2007/057464 filed Jul. 19, 2007, which designates the United States of America, and claims priority to German Application No. 10 2006 033 866.9 filed Jul. 21, 2006, the contents of which are hereby incorporated by reference in their entirety.

### TECHNICAL FIELD

The invention relates to an arrangement comprising nanoparticles.

### BACKGROUND

In this context, the term “nanoparticles” refers to particles which have a particle size of less than one micron—in at least one spatial dimension. As is known, nanoparticles can be used in various fields of technology. For example, the international publication WO 03/095111 A1 describes that nanoparticles can be arranged in array structures.

### SUMMARY

According to various embodiments, an arrangement can be provided which has not only nanoparticle character but also further properties and thus qualifies for still further possible uses.

According to an embodiment, an arrangement may comprise a support and nanoparticles present thereon, wherein at least two nanoparticles which each comprise a metal material and differ in respect of the metal material are arranged at a distance from one another on a support surface of the support, and wherein the two metal materials are noble to a different extent.

According to a further embodiment, the distance between the two nanoparticles can be set so that the two nanoparticles form an electrochemical cell in an electrolyte. According to a further embodiment, the distance between the two nanoparticles may be from 5 μm to 10 μm. According to a further embodiment, the support may consist of an electrically nonconductive material or a material which has poor electrical conductivity. According to a further embodiment, the less noble metal material may be silver or comprises silver. According to a further embodiment, the more noble metal material may consist at least of one of palladium, platinum, rhodium and ruthenium or may comprise one of these metals. According to a further embodiment, a plurality of nanoparticles can be arranged in the manner of a chessboard so that each nanoparticle of one type is surrounded by four nanoparticles of the other type.

According to another embodiment, a process for producing an arrangement may comprise nanoparticles, wherein at least two nanoparticles which each comprise a metal material and differ in respect of the metal material are arranged at a distance from one another on a support surface of the support, and wherein the two metal materials are noble to a different extent.

According to a further embodiment, the distance between the two nanoparticles can be set so that the two nanoparticles form an electrochemical cell in an electrolyte. According to a further embodiment, the distance between the two nanoparticles may be from 5 μm to 10 μm. According to a further embodiment, an electrically nonconductive material or a material which has poor electrical conductivity may be selected for the support. According to a further embodiment, the less noble metal material can be silver or comprises silver. According to a further embodiment, the more noble metal material may consist of at least one of palladium, platinum, rhodium and ruthenium or may comprise one of these metals. According to a further embodiment, a plurality of nanoparticles which include at least two types of nanoparticles comprising metal materials which are noble to a different extent can be applied to the support surface. According to a further embodiment, each nanoparticle may have at least one nanoparticle of the other type arranged directly adjacent to it. According to a further embodiment, the distance between each nanoparticle of the one type and the directly adjacent nanoparticle of the other type can be in the range from 5 μm to 10 μm. According to a further embodiment, a first perforated mask having a predetermined first arrangement of holes can be applied to the support surface of the support, nanoparticles of a first metal material can be affixed to the support surface in the positions determined by the arrangement of holes, a second perforated mask having a predetermined second arrangement of holes can be applied to the support surface, and nanoparticles of a second metal material can be affixed to the support surface in the positions determined by the arrangement of holes in the second perforated mask. According to a further embodiment, the nanoparticles of the first metal material can be formed in the holes of the first perforated mask by the first metal material being deposited on the support surface in the region of the holes, and/or the nanoparticles of the second metal material may be formed in the holes of the second perforated mask by the second metal material being deposited on the support surface in the region of the holes. According to a further embodiment, finished nanoparticles of the first metal material can be introduced into the holes of the first perforated mask and affixed to the support surface and/or finished nanoparticles of the second metal material can be introduced into the holes of the second perforated mask and affixed to the support surface. According to a further embodiment, an auxiliary layer which provides chemical coupling positions for each of the two types of nanoparticles, to which the nanoparticles can couple chemically, can be applied to the support surface, with the coupling positions being located at a distance from one another, and a mixture of finished nanoparticles of at least two metal materials which are noble to a different extent can be applied to the support surface provided with the auxiliary layer and a nanoparticle distribution determined by the arrangement of the coupling positions on the auxiliary layer is achieved on the support. According to a further embodiment, the auxiliary layer may be formed by applying a polymer layer having a molecular structure which provides at least one coupling position for each of the two types of nanoparticles to the support surface. According to a further embodiment, the auxiliary layer can be formed by applying a crosslinking material comprising self-assembling molecules which each provide at least one coupling position to the support surface. According to a further embodiment, the plurality of nanoparticles can be arranged in the manner of a chessboard so that each nanoparticle of one type is surrounded by four nanoparticles of the other type. According to a further embodiment, a mixture of finished nanoparticles of at least two metal materials which are noble to a different extent can be applied to a support provided with a perforated mask.

### BRIEF DESCRIPTION OF THE DRAWINGS

The invention is illustrated below with the aid of various examples; here, by way of example,

FIGS. 1-6 show a first example of a process according to an embodiment for producing an example of an arrangement or structure according to an embodiment, in which two perforated masks are used,

FIGS. 7-11 show a second example of a process according to an embodiment for producing an example of an arrangement or structure according to an embodiment, in which only one perforated mask is used,

FIG. 12 shows a third example of a process according to an embodiment for producing an example of an arrangement or structure according to an embodiment, in which an auxiliary layer is used, and

FIG. 13 shows a fourth example of a process according to an embodiment for producing an example of an arrangement or structure according to an embodiment, in which a type of auxiliary layer different from that in FIG. 12 is used.

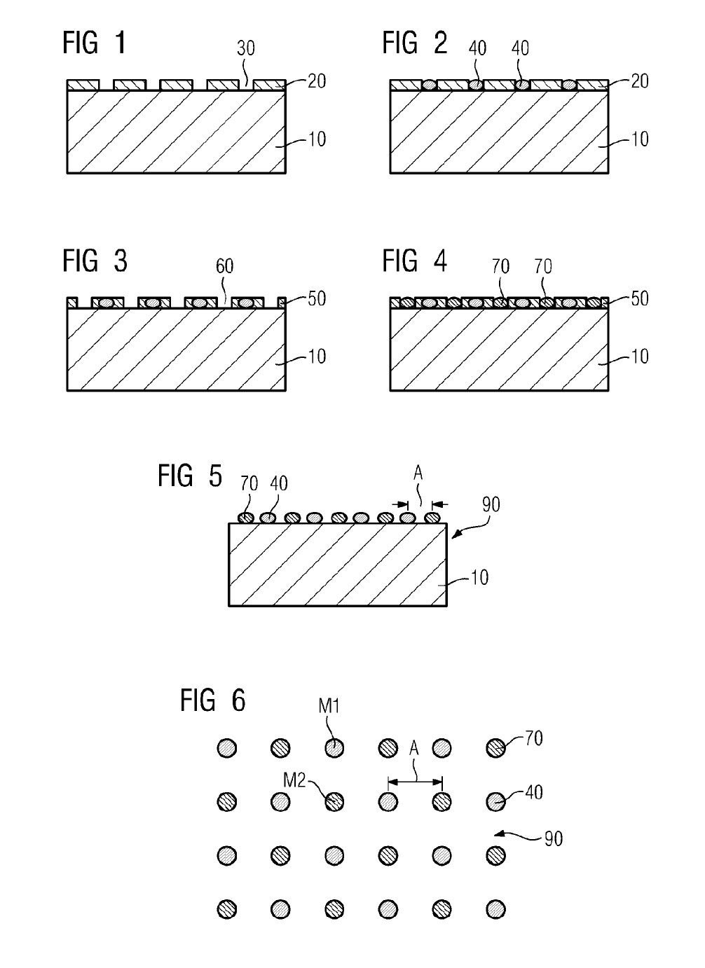

In FIGS. 1 to 13, identical reference signs are used in the interests of clarity for identical or comparable components.

### DETAILED DESCRIPTION

The various embodiments accordingly provide for at least two nanoparticles which each comprise a metal material and are different in respect of the metal material to be arranged at a distance from one another on a support surface of a support, where the two metal materials are noble to a different extent or have different redox potentials.

A significant advantage of the arrangement according to various embodiments is that the nanoparticles can, as a result of the different nobility or the different redox potentials of the metal materials, have further chemical properties: for example, they can form an electrochemical cell as soon as they are brought into contact with an electrolyte. The ability to form an electrochemical cell enables the arrangement to be utilized, for example, in various technical fields, for example in the medical sector. For example, the arrangement can display an antibacterial action when its interaction with an electrolyte results in flow of electric current between the nanoparticles. Apart from use in the medical sector, the arrangement is also, owing to its electrochemical properties, suitable for other applications, for example for the internal coating of condenser tubes, heat exchangers or the like. A lotus flower effect or catalytic effects can also be displayed by the arrangement when suitable materials are selected.

As already mentioned, the distance between the two nanoparticles is preferably set so that the two nanoparticles can form an electrochemical cell in an electrolyte. A distance between the two nanoparticles of from 5 μm to 10 μm is considered to be preferred.

With regard to simple production of the arrangement, it is considered to be advantageous for the support surface to be planar or flat, at least on sections; in this case, the nanoparticles can lie in the same plane, at least approximately spatially in the same plane.

The two metallic materials are preferably formed by pure materials such as chemical elements or metal alloys.

To avoid an electric short circuit between the nanoparticles, it is considered to be advantageous for the support to consist of an electrically nonconductive material or a material which has poor electrical conductivity.

If the arrangement is used in the human or animal body for the purposes of medical procedures, it is considered to be advantageous for the release of metal ions to be minimized since liberated metal ions in the human or animal body can, if the concentration is too high, sometimes cause damage. A release of ions can be reduced, or at least significantly slowed, when the difference between the redox potentials of the materials of the two nanoparticles is very small. The two metallic materials are preferably selected so that the difference between the redox potentials is less than 200 mV. The difference between the redox potentials corresponds to the thermodynamic driving force for the release of ions. The release of ions is, however, also determined by the kinetic properties of the surface, which influence the chemical behavior of the nanoparticles.

For use of the arrangement as antibacterial “active compound” in the human or animal body, it is considered to be advantageous for the less noble metallic material of the two nanoparticles to be formed by silver since silver has an antibacterial action, in particular when together with chloride ions of an electrolyte it forms a silver chloride layer on the particle comprising silver.

To avoid release of silver ions into the human body, the other metallic material should preferably not be much more noble than silver. A suitable partner material for silver is, for example, palladium which has a redox potential of 0.92 V. Since silver has a redox potential of 0.8 V, the difference between the two redox potentials is about 120 mV and therefore relatively low, so that release of silver ions from the silver particle occurs very slowly and/or is prevented for at least some period of time when a silver chloride layer can be formed on the silver particle.

With a view to a very compact construction of the arrangement, it is considered to be advantageous for a plurality of nanoparticles to be arranged in the manner of a chessboard, for example on a flat or planar support surface, in such a way that each nanoparticle of one type is surrounded by four nanoparticles of the other type. In the case of such a positioning of the nanoparticles, a very low density of electrochemical cells per unit area of the support surface can be achieved.

Further embodiments provide a process for producing an arrangement comprising nanoparticles.

In this respect, it is provided according to various embodiments that at least two nanoparticles which each comprise a metal material and differ in respect of the metal material are applied at a distance from one another to a support surface of a support, where the two metal materials are noble to a different extent.

As regards the advantages of the process resulting from the different nobility of the two metal materials, reference may be made to what has been said above in connection with the arrangement according to various embodiments.

As already mentioned, the distance between the two nanoparticles is preferably set so that the two nanoparticles can form an electrochemical cell in an electrolyte. For example, the distance between the two nanoparticles is in the range from 5 μm to 10 μm.

To avoid a situation where the support prevents formation of electrochemical cells between the nanoparticles or makes this difficult, it is considered to be advantageous for an electrically nonconductive material or a material which has poor electrical conductivity to be used as support material.

As already mentioned, preference is given to using silver or a silver-containing material as the less noble metal material. As the more noble metal material, preference is given to using palladium, platinum, rhodium and/or ruthenium or a material which contains this metal or a plurality of these metals.

Particular preference is given to applying a plurality of nanoparticles, namely at least two types of nanoparticles which comprise metal materials which are noble to a different extent, to the support surface. Each nanoparticle preferably has at least one nanoparticle of the other type arranged directly adjacent to it.

As regards the formation of electrochemical cells, it is considered to be advantageous for the distance between each nanoparticle of the one type and the directly adjacent nanoparticle of the other type to be from 5 μm to 10 μm.

In a particularly preferred variant, it is considered to be advantageous for a first perforated mask having a predetermined first arrangement of holes to be applied to the support surface of the support, for nanoparticles of a first metal material to be affixed to the support surface in the positions determined by the arrangement of holes, for a second perforated mask having a predetermined second arrangement of holes to be applied to the support surface and for nanoparticles of a second metal material to be affixed to the support surface in the positions determined by the second perforated mask.

For example, the nanoparticles of the first metal material are formed in the holes of the first perforated mask by the first metal material being deposited on the support surface, in particular grown onto the support surface, in the region of the holes, and/or the nanoparticles of the second metal material are formed in the holes of the second perforated mask by the second metal material being deposited on the support surface, in particular grown onto the support surface, in the region of the holes. Growing on can be effected, for example, electrochemically in an electrochemical bath.

As an alternative, finished nanoparticles of the first metal material can be introduced into the holes of the first perforated mask and affixed to the support surface, and/or finished nanoparticles of the second metal material can be introduced into the holes of the second perforated mask and affixed to the support surface.

In another preferred variant, it is considered to be advantageous for an auxiliary layer which provides chemical coupling positions for each of the at least two types of nanoparticles, to which the nanoparticles can be chemically coupled, to be applied to the support surface, with the coupling positions being located at a distance from one another, for a mixture of finished nanoparticles of at least two metal materials which are noble to a different extent to be applied to the support surface provided with the auxiliary layer and for a nanoparticle distribution predetermined by the arrangement of the coupling positions on the auxiliary layer to be achieved on the support.

For example, the auxiliary layer is formed by applying a polymer layer having a molecular structure which provides at least one coupling position for each of the two types of nanoparticles to the support surface.

As an alternative, the auxiliary layer can be formed by applying a crosslinking material having self-assembling molecules which each provide at least one coupling position to the support surface.

With a view to a maximum density of electrochemical cells per unit area, it is considered to be advantageous for the plurality of nanoparticles to be arranged in the manner of a chessboard so that each nanoparticle of one type is surrounded by four nanoparticles of the other type.

In another preferred variant, it is considered to be advantageous for a mixture of finished nanoparticles of at least two metal materials which are noble to a different extent to be applied to a support provided with a perforated mask, and for a nanoparticle distribution which is predetermined by the stoichiometry, or is random or stochastic to be achieved on the support.

In conjunction with FIGS. 1 to 6, a first example of a process for producing an arrangement comprising nanoparticles will now be described.

In FIG. 1, it is possible to see a support 10 on which a first photomask 20 has been applied. The photomask 20 is structured and has holes 30; the photomask 20 thus forms a perforated mask. The structuring of the photomask 20 can be carried out in a customary way, for example by electron beam structuring, laser structuring or another optical structuring method.

Nanoparticles 40 are then grown onto the support 10 which has been coated in this way, by applying a first metal material M1 to the support 10. The growing-on of the nanoparticles 40 can be effected in any way, for example in a vapor deposition step (e.g. CVD step) or a sputtering step. In addition, the deposition of the metal material M1 can be aided magnetically or electrostatically. Deposition of the metal material M1 by an electrochemical route, for example in an electroplating bath in the form of an “electroforming” step, is also possible.

The structure provided with the nanoparticles 40 is shown in FIG. 2; the first photomask 20 is still present.

After deposition of the nanoparticles 40, the first photomask 20 is removed completely and a second photomask 50 is subsequently applied. The second photomask 50 is likewise structured so that holes 60 are formed. During the application of the second photomask or perforated mask 50, the nanoparticles 40 which have been deposited in the preceding step are embedded in the second photomask 50; this is shown schematically in FIG. 3.

In a second deposition step, nanoparticles 70 of a second metal material M2 are then deposited; these nanoparticles 70 therefore form a different type of nanoparticles. The growing-on of the second metal material M2 is carried out in a manner comparable to the growing-on of the first metal material M1, i.e., for example, as has been described in relation to FIG. 2. The resulting structure is shown in FIG. 4.

After detachment of the second perforated mask 50, there remains a finished arrangement 90 in which nanoparticles 40 of a first metal material M1 and nanoparticles 70 of a second metal material M2 have been applied to the support 10. The distance between nanoparticles of different metal materials is denoted by the reference sign A in FIG. 5. The spacing A is preferably from about 5 to 10 μm.

The two materials M1 and M2 are selected so that the redox potentials of the two materials M1 and M2 are different. In the following, it is assumed by way of example that the first material M1 of the nanoparticles 40 is a metal which is less noble, or a metal alloy which is less noble, than the second material M2 of the nanoparticles 70.

The property of a metal of being noble or not noble is indicated by the respective redox potential or the electrochemical potential series; the following list, which is illustrative and not intended to be conclusive, of metals suitable for nanoparticles is ordered from not noble to noble or in order of increasing redox potentials (redox potential versus standard hydrogen electrode at 25° C.):

| | |
|---|---|
| lithium | −3 V |
| magnesium | −2.4 V |
| aluminum | −1.7 V |
| zinc | −0.8 V |
| silver | +0.8 V |
| palladium | +0.9 V |

A material which is very suitable, in particular with a view to medical applications, is, for example, silver since silver or silver ions has/have an antibacterial action. Accordingly, it is assumed below by way of example that silver is used as first not noble material M1 since the less noble material can release ions in an electrolyte in an electrochemical cell.

The second material M2 of the nanoparticles 70 is accordingly a more noble metal, for example gold or palladium. Palladium has a redox potential of 0.92 V, which is relatively similar to that of silver so that the difference D between the redox potentials of the two materials M1 (silver) and M2 (palladium) is only D=120 mV.

If the structure 90 as shown in FIG. 5 is brought into contact with an electrolyte by, for example, introducing it into the human body, the silver material M1 will react with chloride ions, which are always present in body fluids or cell fluids of the human body, of the electrolyte so that a highly chemically stable silver chloride layer will form on the nanoparticles 40. This silver chloride layer will separate the surface of the nanoparticles 40 from the electrolyte, so that direct release of silver ions from the nanoparticles 40 into the electrolyte is prevented or at least greatly slowed. The formation of the silver chloride layer on the surface of the nanoparticles 40 thus ensures that no unacceptably high release of silver ions into the human body can occur. Nevertheless, an antibacterial effect is achieved since the silver chloride layer itself acts as a bactericide.

Instead of the silver/palladium materials combination described, it is also possible to use other materials combinations, in particular ones based on silver, in order to display an antibacterial action: other suitable materials combinations are, for example, silver-platinum, silver-ruthenium and silver-rhodium.

In the selection of the materials, it should preferably be ensured that, when silver is used, the not noble material of the two materials M1 and M2 is formed by the silver so that it can generate ions and/or form the silver chloride layer described. In addition, the difference between the redox potentials should not be too great. Potential differences which are too great increase the reactivity of the electrochemical cell, so that excessively rapid release of silver ions which may be too high for human or animal bodies could occur. The potential difference is preferably less than 500 mV.

FIG. 6 shows the resulting structure 90 from above. It can be seen that the nanoparticles 40 and the nanoparticles 70 are arranged in the manner of a chessboard so that each nanoparticle of one type is surrounded by four adjacent partner nanoparticles of the other type.

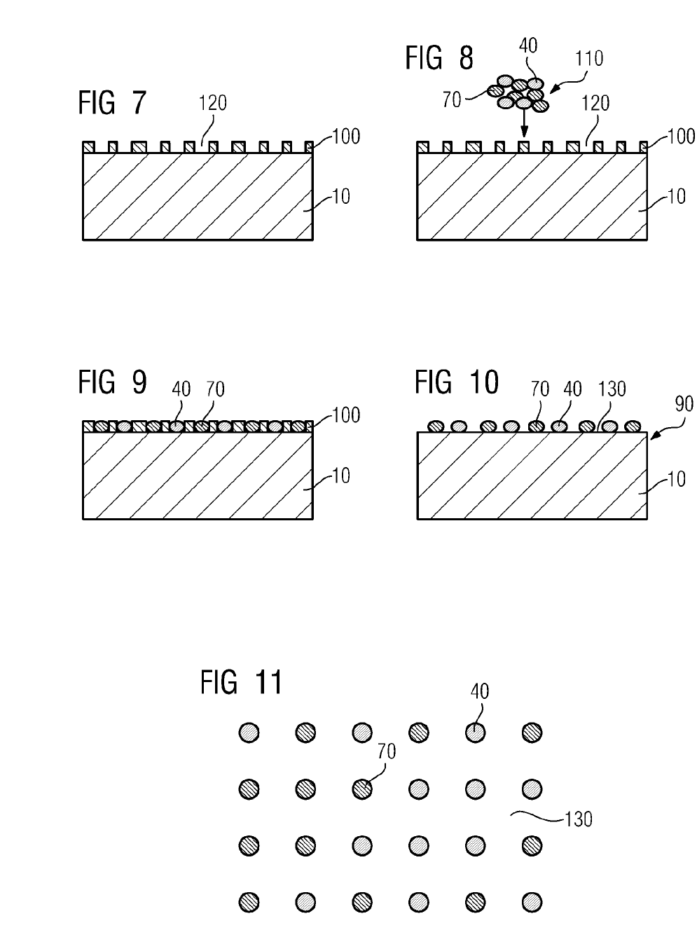

In conjunction with FIGS. 7 to 11, a second example of the production of an arrangement comprising nanoparticles will now be described.

In FIG. 7, it is possible to see a support 10 to which a perforated mask 100 has been applied. The perforated mask 100 can again be formed by an appropriately structured photomask.

A mixture of finished nanoparticles 110 is then applied to the support 10 provided with the perforated mask 100. The mixture 110 comprises nanoparticles 40 of a first metal material M1 and nanoparticles 70 of a second metal material M2. The mixture has such a composition that the number of nanoparticles of the first metal material M1 corresponds approximately to the proportion of nanoparticles of the second metal material M2.

The mixture 110 is then applied to the support 10 provided with the perforated mask 100 so that the openings or holes 120 of the perforated mask 100 are filled with the nanoparticles 40 or 70. The distribution of the nanoparticles 40 or 70 in the openings 120 is random and depends essentially on the composition of the mixture 110. The resulting structure after application of the mixture 110 is shown schematically in FIG. 9.

FIG. 10 shows the arrangement comprising the support 10 and the nanoparticles 40 and 70 after the perforated mask 100 has been removed. To affix the nanoparticles 40 or 70 to the support surface 130 of the support 10, the nanoparticles can be affixed by means of an additional fixing material. Such a fixing material is not shown further in FIG. 10 for reasons of clarity.

FIG. 11 shows, in plan view, the distribution of the nanoparticles 40 and 70 on the support surface 130 of the support 10. It can be seen that, in contrast to the first example shown in FIGS. 1 to 6, the nanoparticles are not distributed in the manner of a chessboard but are distributed randomly. The distribution of the nanoparticles on the support surface 130 is determined by the random distribution or composition of the mixture 110 of the nanoparticles 40 and 70.

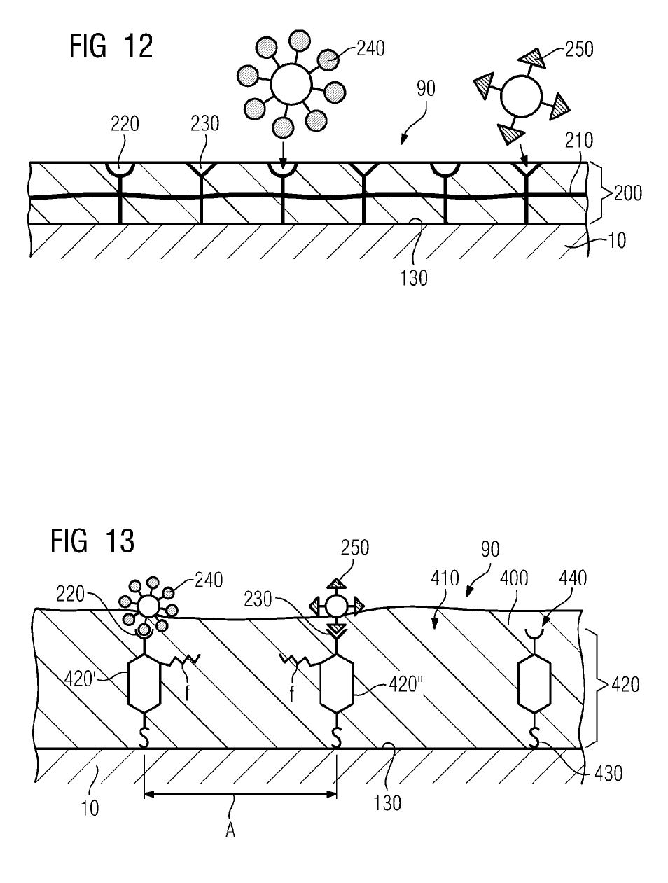

In conjunction with FIG. 12, a third example of a process for producing an arrangement comprising a support and nanoparticles will now be described. A support 10 to which an auxiliary layer 200 has been applied can be seen in FIG. 12. The auxiliary layer 200 is, for example, a polymer layer which comprises chain-like molecules 210. The chain-like molecules 210 are aligned along or parallel to the support surface 130 of the support 10. As can be seen in FIG. 12, the chain-like molecules 210 are provided with a plurality of coupling positions 220 and 230 to which nanoparticles can couple.

In the example shown in FIG. 12, it is assumed by way of example that the coupling positions 220 are suitable or designed for coupling to silver nanoparticles 240 and that the coupling positions 230 are suitable or designed for coupling to palladium nanoparticles 250. The corresponding coupling possibilities are shown schematically in FIG. 12 by the shape of the coupling positions 220 and 230 or by the shape of the corresponding countercoupling positions of the palladium nanoparticles 250 and the silver nanoparticles 240.

In the third example as shown in FIG. 12, it is assumed that the auxiliary layer 200 is specifically suitable for coupling of palladium nanoparticles 250 and silver nanoparticles 240; of course, it can be ensured by means of an appropriate configuration of the molecular structure of the chain-like molecules 210 that other types of nanoparticles can be attached in a corresponding way.

A suitable material for the auxiliary layer 200 is, for example, cetyltrialkylammonium bromide.

After the support 10 has been provided with the auxiliary layer 200 described, a mixture of finished nanoparticles 240 and 250 is applied to the auxiliary layer 200. Owing to the coupling points 220 and 230 provided by the auxiliary layer 200, the nanoparticles 240 and 250 are correspondingly coupled to the auxiliary layer 200, so that they become attached in a predetermined manner to the support 10. The arrangement 90 comprising the support 10 and the nanoparticles 240 and 250 is then finished.

In conjunction with FIG. 13, a fourth example of a process for producing an arrangement 90 comprising a support 10 and nanoparticles will now be described. In this example, an auxiliary layer 400 formed by a crosslinking base material 410 with self-assembling molecules 420 present therein is applied to the support surface 130 of the support 10. The auxiliary layer 400 thus itself forms a self-assembling layer.

The self-assembling molecules 420 are configured so that they couple by a molecule end 430 to the support surface 130 of the support 10. By means of another molecule end 440, they form a coupling position to which the nanoparticles having an appropriate countercoupling position can couple. The left-hand molecule 420′ in FIG. 13 forms, for example, a coupling position 220 for the silver nanoparticles 240 and the middle molecule 420″ in FIG. 13 forms, for example, a coupling position 230 for the palladium nanoparticles 250.

The molecules 420 also have functional groups f which fix the distance A between the molecules 420. The distance A between the molecules 420 thus at the same time defines the spacing A which the nanoparticles 240 and 250 will have on the support 10.

After coupling of the nanoparticles 240 or 250 to the molecules 420 and thus to the support 10, the base material 410 can be removed so that only the molecules 420 and the nanoparticles 240 and 250 are now present on the support 10.

A suitable material for the auxiliary layer 400 is, for example, material having oligomeric chains comprising polythiophene derivatives.

What is claimed is:

1. An arrangement comprising a support and nanoparticles present thereon, wherein
at least two nanoparticles which each comprise a metal material and differ in respect of the metal material are arranged at a distance from one another on a support surface of the support, and
wherein the two metal materials are noble to a different extent.

2. The arrangement according to claim 1, wherein the distance between the two nanoparticles is set so that the two nanoparticles form an electrochemical cell in an electrolyte.

3. The arrangement according to claim 1, wherein the distance between the two nanoparticles is from 5 μm to 10 μm.

4. The arrangement according to claim 1, wherein the support consists of an electrically nonconductive material or a material which has poor electrical conductivity.

5. The arrangement according to claim 1, wherein the less noble metal material is silver or comprises silver.

6. The arrangement according to claim 1, wherein the more noble metal material consists at least of one of palladium, platinum, rhodium and ruthenium or comprises one of these metals.

7. The arrangement according to claim 1, wherein a plurality of nanoparticles are arranged in the manner of a chessboard so that each nanoparticle of one type is surrounded by four nanoparticles of the other type.

8. A process for producing an arrangement comprising nanoparticles, wherein
at least two nanoparticles which each comprise a metal material and differ in respect of the metal material are arranged at a distance from one another on a support surface of the support, and
wherein the two metal materials are noble to a different extent.

9. The process according to claim 8, wherein the distance between the two nanoparticles is set so that the two nanoparticles form an electrochemical cell in an electrolyte.

10. The process according to claim 8, wherein the distance between the two nanoparticles is from 5 μm to 10 μm.

11. The process according to claim 8, wherein an electrically nonconductive material or a material which has poor electrical conductivity is selected for the support.

12. The process according to claim 8, wherein the less noble metal material is silver or comprises silver.

13. The process according to claim 8, wherein the more noble metal material consists of at least one of palladium, platinum, rhodium and ruthenium or comprises one of these metals.

14. The process according to claim 8, wherein
a plurality of nanoparticles which include at least two types of nanoparticles comprising metal materials which are noble to a different extent are applied to the support surface.

15. The process according to claim 14, wherein nanoparticle has at least one nanoparticle of the other type arranged directly adjacent to it.

16. The process according to claim 14, wherein the distance between each nanoparticle of the one type and the directly adjacent nanoparticle of the other type is in the range from 5 μm to 10 μm.

17. The process according to claim 14, wherein
a first perforated mask having a predetermined first arrangement of holes is applied to the support surface of the support,
nanoparticles of a first metal material are affixed to the support surface in the positions determined by the arrangement of holes,
a second perforated mask having a predetermined second arrangement of holes is applied to the support surface, and
nanoparticles of a second metal material are affixed to the support surface in the positions determined by the arrangement of holes in the second perforated mask.

18. The process according to claim 17, wherein at least one of the following conditions is true
the nanoparticles of the first metal material are formed in the holes of the first perforated mask by the first metal material being deposited on the support surface in the region of the holes, and
the nanoparticles of the second metal material being formed in the holes of the second perforated mask by the second metal material being deposited on the support surface in the region of the holes.

19. The process according to claim 17, wherein at least one of the following conditions is true:
finished nanoparticles of the first metal material are introduced into the holes of the first perforated mask and affixed to the support surface and
finished nanoparticles of the second metal material are introduced into the holes of the second perforated mask and affixed to the support surface.

20. The process according to claim 14, wherein
an auxiliary layer which provides chemical coupling positions for each of the two types of nanoparticles, to which the nanoparticles can couple chemically, is applied to the support surface, with the coupling positions being located at a distance from one another, and
a mixture of finished nanoparticles of at least two metal materials which are noble to a different extent is applied to the support surface provided with the auxiliary layer and a nanoparticle distribution determined by the arrangement of the coupling positions on the auxiliary layer is achieved on the support.

21. The process according to claim 20, wherein
the auxiliary layer is formed by applying a polymer layer having a molecular structure which provides at least one coupling position for each of the two types of nanoparticles to the support surface.

22. The process according to claim 20, wherein the auxiliary layer is formed by applying a crosslinking material comprising self-assembling molecules which each provide at least one coupling position to the support surface.

23. The process according to claim 14, wherein the plurality of nanoparticles are arranged in the manner of a chessboard so that each nanoparticle of one type is surrounded by four nanoparticles of the other type.

24. The process according to claim 14, wherein a mixture of finished nanoparticles of at least two metal materials which are noble to a different extent is applied to a support provided with a perforated mask.
